(19) United States
(12) Patent Application Publication
(10) Pub. No.: US 2018/0154782 A1
(43) Pub. Date: Jun. 7, 2018

(54) Water Cooled Type Cooling-Heating System for Vehicle

(71) Applicants: Hyundai Motor Company, Seoul (KR); Kia Motors Corporation, Seoul (KR)

(72) Inventor: Gun Goo Lee, Suwon-si (KR)

(21) Appl. No.: 15/605,605

(22) Filed: May 25, 2017

(30) Foreign Application Priority Data
Dec. 1, 2016 (KR) 10-2016-0162536

(51) Int. Cl. B60L 11/18; H01M 10/625; H01M 10/6568; H01M 10/635

(52) U.S. Cl. CPC B60L 11/187; B60L 11/1874; B60L 11/1875; B60K 2001/008; H01M 10/6568; H01M 10/635; H01M 10/625

(57) ABSTRACT

A water cooled type cooling-heating system for cooling or heating power supply components in a vehicle has a first passage with a first water pump, a battery heater, and a battery system. A second passage that is branched from the first passage, and having a second water pump and a power electronic component is disposed in order thereon. A third passage branched from the first passage, and including a radiator and a chiller to move the cooling water. A first three way valve is disposed at a point between a rear of the battery system and the second water pump where the first passage and the second passage meet. A second three way valve is disposed at a point where the first passage and the third passage meet. A controller circulates the cooling water so as to cool or heat the battery system and cool of the power electronic component.

### CROSS-REFERENCE TO RELATED APPLICATIONS

The present application claims priority to Korean Patent Application No. 10-2016-0162536, filed on Dec. 1, 2016, the entire contents of which is incorporated herein for all purposes by this reference.

### TECHNICAL FIELD

The present invention relates to a water cooled type cooling-heating system for a vehicle.

### BACKGROUND

In recent years, eco-friendly vehicles such as a hybrid vehicles use both a fossil fuel engine and an electric motor driven by electricity as a driving source, and vehicles using only an electric motor have been developed and marketed as one of the countermeasures against exhaustion of fossil fuels and environmental pollution.

The eco-friendly vehicle has a battery for driving the electric motor. Here, the battery for the eco-friendly vehicle has mainly used a lithium secondary battery in consideration of energy density per unit weight. The lithium secondary battery is mainly manufactured in a pouch type and is applied to the eco-friendly vehicles and when the pouch type battery is applied to the eco-friendly vehicles, several pouch type batteries are connected in series for high output power.

On the other hand, when the battery for driving the electric motor of the eco-friendly vehicle is used for a long period time, an increase in surface temperature of the battery and a reduction in lifetime thereof are inevitable. Therefore, it is important to manage the temperature of the battery to efficiently use the battery while lowering a temperature of the battery. Therefore, a separate cooling apparatus for cooling a battery of an eco-friendly vehicle is essentially installed.

As the type of cooling the pouch type battery using the battery cooling apparatus, there are a water cooled type of performing cooling by disposing a plate type heat exchanger between the pouch type batteries and circulating cooling water into the plate type heat exchanger and an air cooling type of performing cooling by forcibly sucking air outside a vehicle by using a blower.

The matters described as the related art have been provided only for assisting in the understanding for the background of the present invention and should not be considered as corresponding to the related art known to those skilled in the art.

### SUMMARY

An object of the present invention is to provide a water cooled type cooling-heating system capable of effectively cooling or heating a battery system and increasing a driving distance and durability of parts by efficiently cooling a power electronic component.

According to an exemplary embodiment of the present invention, there is provided a water cooled type cooling-heating system for cooling or heating a battery system and cooling a power electronic component, in a vehicle equipped with a high voltage battery by cooling water, the water cooled type cooling-heating system including: a first passage configured to have a first water pump, a battery heater, and the battery system disposed in order thereon so as to circulate the cooling water; a second passage configured to be branched from the first passage, have a parallel structure with the first passage, and have a second water pump and the power electronic component disposed in order thereon so as to move the cooling water; a third passage configured to be branched from the first passage, have a parallel structure with the first passage, and include a radiator and a chiller to move the cooling water so as to perform cooling; a first three way valve configured to be disposed at a point between a rear of the battery system and the second water pump where the first passage and the second passage are met and include a first stage into which the cooling water discharged from the battery system is introduced, a second stage through which the cooling water is discharged to the first passage, and a third stage through which the cooling water is discharged to the first water pump to selectively move the cooling water; a second three way valve configured to be disposed at a point where the first passage and the third passage are met and include a first stage into which the cooling water is introduced from the first passage, a second stage through which the cooling water is discharged to the first passage, and a third stage through which the cooling water is discharged to the third passage to selectively move the cooling water; and a controller configured to separately control the first water pump, the second water pump, the battery heater, and the chiller to be turned on and off and separately control the first three way valve and the second three way valve to be closed and open to circulate the cooling water to cool or heat the battery system and cool the power electronic component.

The chiller may be disposed in back of the radiator.

When the battery system needs to be cooled, the controller may control the first water pump to be turned on and the first stage and the second stage of the first three way valve and the first stage and the third stage of the second three way valve to be open, such that the cooling water of the first water pump cools the battery system and the heated cooling water moves in the first passage through the first three way valve and is introduced into the third passage through the second three way valve to be cooled by the radiator and then moves in the first passage to pass through the first water pump again and be supplied to the battery system.

When the battery system and the power electronic component need to be cooled, the controller may control the first water pump and the second water pump to be turned on and the first stage and the third stage of the first three way valve and the first stage and the third stage of the second three way valve to be open, such that the cooling water of the first water pump cools the battery system and then moves in the second passage through the first three way valve and is introduced into the second water pump and the cooling water of the second water pump cools the power electronic component and then moves in the first passage to move in the third passage through the second three way valve to be cooled by the radiator and then moves in the first passage to pass through the first water pump again and be supplied to the battery system.

When the battery system needs to be cooled, the controller may control the first water pump and the chiller to be turned on and the first stage and the second stage of the first three way valve and the first stage and the third stage of the second three way valve to be open, such that the cooling water of the first water pump cools the battery system and the heated cooling water moves in the first passage through the first three way valve, and moves in the third passage through the second three way valve to be cooled by the radiator and then passes through the chiller to be cooled once more and then moves in the first passage to pass through the first water pump again and be supplied to the battery system.

When the battery system and the power electronic component need to be cooled, the controller may control the first water pump, the second water pump, and the chiller to be turned on and the first stage and the third stage of the first three way valve and the first stage and the third stage of the second three way valve to be open, such that the cooling water of the first water pump cools the battery system and then moves in the second passage through the first three way valve to cool the power electronic component using the second water pump and the heated cooling water moves in the first passage to move in the third passage through the second three way valve to be cooled by the radiator and then passes through the chiller to be cooled once more and then moves in the first passage to pass through the first water pump again and be supplied to the battery system.

When the battery system needs to be heated, the controller may control the first water pump and the battery heater to be turned on and the first stage and the second stage of the first three way valve and the first stage and the second stage of the second three way valve to be open, such that the cooling water of the first water pump passes through the battery heater to be heated and then is introduced into the battery system to heat the battery system and is circulated in the first passage through the first three way valve and the second three way valve to pass through the first water pump again so as to pass through the battery heater and be supplied to the battery system.

A rear of the radiator may be provided with a fourth passage branched from the third passage to form the closed loop, the fourth passage may be provided with the chiller, and a point where the third passage and the fourth passage are met may be provided with a third three way valve including a first stage into which the cooling water discharged from the radiator is introduced, a second stage through which the cooling water is introduced into the chiller, and a third stage through which the cooling water is discharged from the chiller.

When the battery system needs to be cooled, the controller may control the first water pump to be turned on and the first stage and the second stage of the first three way valve, the first stage and the third stage of the second three way valve, and the first stage and the third stage of the third three way valve to be open, such that the cooling water of the first water pump cools the battery system and the heated cooling water moves in the first passage through the first three way valve and is introduced into the third passage through the second three way valve to be cooled by the radiator and then moves in the first passage through the third three way valve to pass through the first water pump again and be supplied to the battery system.

When the battery system and the power electronic component need to be cooled, the controller may control the first water pump and the second water pump to be turned on and the first stage and the third stage of the first three way valve, the first stage and the third stage of the second three way valve, and the first stage and the third stage of the third three way valve to be open, such that the cooling water of the first water pump cools the battery system and then moves in the second passage through the first three way valve and is introduced into the second water pump and the cooling water of the second water pump cools the power electronic component and then moves in the first passage to move in the third passage through the second three way valve to be cooled by the radiator and then moves in the first passage through the third three way valve to pass through the first water pump again and be supplied to the battery system.

When the battery system needs to be cooled, the controller may control the first water pump and the chiller to be turned on and the first stage and the second stage of the first three way valve, the first stage and the third stage of the second three way valve, and the first stage and the second stage of the third three way valve to be open, such that the cooling water of the first water pump cools the battery system and the heated cooling water moves in the first passage through the first three way valve, and moves in the third passage through the second three way valve to be cooled by the radiator and then is introduced into the fourth passage through the third three way valve to pass through the chiller to be cooled once more and then moves in the first passage to pass through the first water pump again and be supplied to the battery system.

When the battery system and the power electronic component need to be cooled, the controller may control the first water pump, the second water pump, and the chiller to be turned on and the first stage and the third stage of the first three way valve, the first stage and the third stage of the second three way valve, and the first stage and the second stage of the third three way valve to be open, such that the cooling water of the first water pump cools the battery system and then moves in the second passage through the first three way valve to cool the power electronic component using the second water pump and the heated cooling water moves in the first passage to move in the third passage through the second three way valve to be cooled by the radiator and then is introduced into the fourth passage through the third three way valve to pass through the chiller to be cooled once more and then moves in the first passage to pass through the first water pump again and be supplied to the battery system.

When the battery system needs to be heated, the controller may control the first water pump and the battery heater to be turned on and the first stage and the second stage of the first three way valve and the first stage and the second stage of the second three way valve to be open, such that the cooling water of the first water pump passes through the battery heater to be heated and then is introduced into the battery system to heat the battery system and is circulated in the first passage through the first three way valve and the second three way valve to pass through the first water pump again so as to pass through the battery heater and be supplied to the battery system.

### BRIEF DESCRIPTION OF THE DRAWINGS

FIG. 1 is a diagram illustrating a water cooled type cooling-heating system according to a first exemplary embodiment of the present invention.

FIG. 2 is a diagram illustrating a flow of cooling water when only a battery system is cooled by a radiator.

FIG. 3 is a diagram illustrating a flow of cooling water when the battery system and a power electronic component are simultaneously cooled by the radiator.

FIG. 4 is a diagram illustrating a flow of cooling water when only the battery system is cooled by the radiator and a chiller.

FIG. 5 is a diagram illustrating a flow of cooling water when the battery system and the power electronic component are simultaneously cooled by the radiator and the chiller.

FIG. 6 is a diagram illustrating a flow of cooling water when only the battery system is heated by a battery heater.

FIG. 7 is a diagram illustrating a water cooled type cooling-heating system according to a second exemplary embodiment of the present invention.

FIG. 8 is a diagram illustrating a flow of cooling water when only a battery system is cooled by a radiator.

FIG. 9 is a diagram illustrating a flow of cooling water when the battery system and a power electronic component are simultaneously cooled by the radiator.

FIG. 10 is a diagram illustrating a flow of cooling water when only the battery system is cooled by the radiator and a chiller.

FIG. 11 is a diagram illustrating a flow of cooling water when the battery system and the power electronic component are simultaneously cooled by the radiator and the chiller.

FIG. 12 is a diagram illustrating a flow of cooling water when only the battery system is heated by a battery heater.

### DETAILED DESCRIPTION OF ILLUSTRATIVE EMBODIMENTS

The present invention relates to a water cooled type cooling-heating system for an eco-friendly vehicle equipped with a high voltage battery system, and more particularly, to a water cooled type cooling-heating system for cooling or heating a battery system in consideration of environmental situations and cooling a power electronic component, while a vehicle is driving.

Hereinafter, a water cooled type cooling-heating system according to an exemplary embodiment of the present invention will be described with reference to the accompanying drawings.

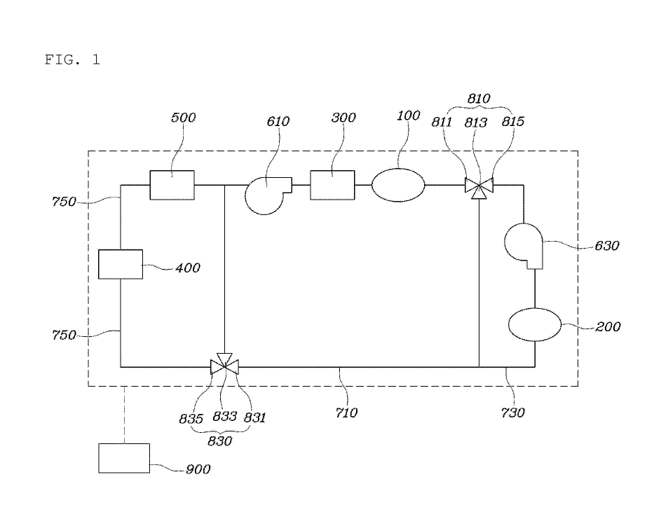

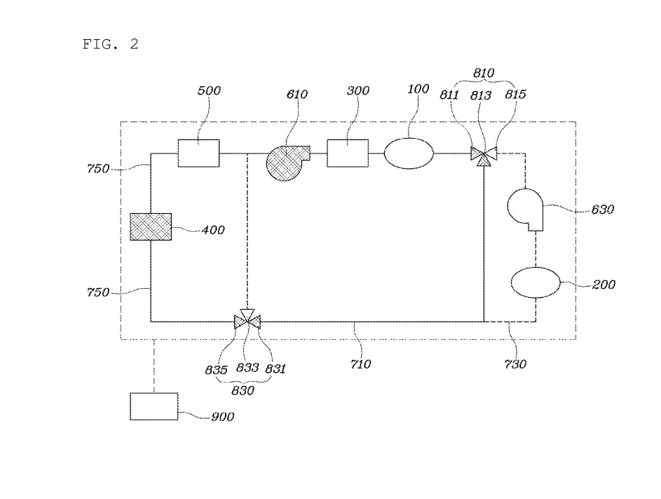

FIG. 1 is a diagram illustrating a water cooled type cooling-heating system according to a first exemplary embodiment of the present invention and FIGS. 2 to 6 are diagrams illustrating control methods in each case.

As illustrated in FIG. 1, according to a first exemplary embodiment of the present invention, a water cooled type cooling-heating system for cooling or heating a battery system 100 and cooling a power electronic component 200, in a vehicle equipped with a high voltage battery by cooling water includes: a first passage 710 configured to have a first water pump 610, a battery heater 300, and the battery system 100 disposed in order thereon so as to circulate the cooling water; a second passage 730 configured to be branched from the first passage 710, have a parallel structure with the first passage 710, and have a second water pump 630 and the power electronic component 200 disposed in order thereon so as to move the cooling water; a third passage 750 configured to be branched from the first passage 710, have a parallel structure with the first passage 710, and include a radiator 400 and a chiller 500 to move the cooling water so as to perform cooling; a first three way valve 810 configured to be disposed at a point between a rear of the battery system 100 and the second water pump 630 where the first passage 710 and the second passage 730 are met and include a first stage 811 into which the cooling water discharged from the battery system 100 is introduced, a second stage 813 through which the cooling water is discharged to the first passage 710, and a third stage 815 through which the cooling water is discharged to the first water pump 610 to selectively move the cooling water; a second three way valve 830 configured to be disposed at a point where the first passage 710 and the third passage 750 are met and include a first stage 831 into which the cooling water is introduced from the first passage 710, a second stage 833 through which the cooling water is discharged to the first passage 710, and a third stage 835 through which the cooling water is discharged to the third passage 750 to selectively move the cooling water; and a controller 900 configured to separately control the first water pump 610, the second water pump 630, the battery heater 300, and the chiller 500 to be turned on and off and separately control the first three way valve 810 and the second three way valve 830 to be closed and open to circulate the cooling water so as to cool or heat the battery system 100 and cool the power electronic component 200. According to the first exemplary embodiment of the present invention, the chiller 500 is positioned in back of the radiator 400.

The water cooled type cooling-heating system according to the exemplary embodiment of the present invention will be separately described in each case with reference to the accompanying drawings.

FIG. 2 is a diagram illustrating a flow of cooling water when only the battery system 100 is cooled by the radiator 400. When the battery system 100 needs to be cooled due to driving of a vehicle, or the like, the controller 900 controls the first water pump 610 to be turned on and controls the first stage 811 and the second stage 813 of the first three way valve 810 and the first stage 831 and the third stage 835 of the second three way valve 830 to be open. Therefore, one closed loop consisting of the first water pump 610, the battery heater 300, the battery system 100, the first three way valve 810, the first passage 710, the second three way valve 830, the third passage 750, the radiator 400, and the chiller 500 is formed, such that the cooling water is repeatedly circulated in the closed loop.

First, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710 through the first three way valve 810, the heated cooling water is introduced into the first stage 811 of the first three way valve 810 and then discharged to the second stage 813. After the cooling water is introduced into the first stage 831 of the second three way valve 830, discharged to the third stage 835, and introduced into the third passage 750 to be cooled by the radiator 400, the cooling water moves in the first passage 710 to pass through the first water pump 610 again and be supplied to the battery system 100 to thereby be repeatedly circulated in the closed loop, thereby cooling the battery system 100. Here, the cooling water passing through the radiator 400 passes through the chiller 500 but the chiller 500 is in the turned off state like the battery heater 300 and therefore has no effect on the temperature of the cooling water.

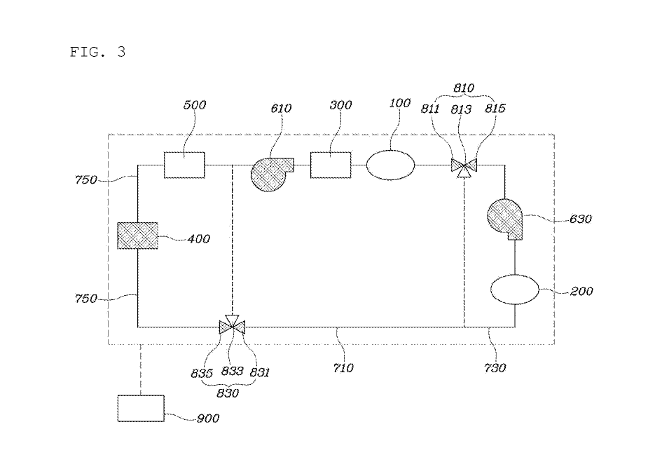

Second, FIG. 3 is a diagram illustrating a flow of cooling water when the battery system 100 and the power electronic component 200 are simultaneously cooled by the radiator 400. When the battery system 100 and the power electronic component 200 need to be cooled due to driving of a vehicle, or the like, the controller 900 controls the first water pump 610 and the second water pump 630 to be turned on and controls the first stage 811 and the third stage 815 of the first three way valve 810 and the first stage 831 and the third stage 835 of the second three way valve 830 to be open.

To simultaneously cool the battery system 100 and the power electronic component 200, first, one closed loop consisting of the first water pump 610, the battery heater 300, the battery system 100, the first passage 710, the first three way valve 810, the second passage 730, the second water pump 630, the power electronic component 200, the first passage 710, the second three way valve 830, the third passage 750, the radiator 400, and the chiller 500 is formed, such that the cooling water is repeatedly circulated in the closed loop. As described above, when the battery system 100 and the power electronic component 200 are simultaneously cooled, a part of the first passage 710 is blocked by the first three way valve 810 and the second three way valve 830 and all of the battery system 100, the power electronic component 200, and the radiator 400 are connected in series to form one closed loop to thereby circulate the cooling water.

Describing the flow of the cooling water, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710, the heated cooling water is introduced into the first stage 811 of the first three way valve 810, discharged to the third stage 815, moves in the second passage 730, and then is introduced into the second water pump 630. After the cooling water introduced into the second water pump 630 cools the power electronic component 200, moves in the first passage 710, is introduced into the first stage 831 of the second three way valve 830, is discharged to the third stage 835, and moves in the third passage 750 to be cooled by the radiator 400, the cooling water moves in the first passage 710 through the chiller 500 to pass through the first water pump 610 again and be supplied to the battery system 100 to thereby be repeatedly circulated in the closed loop, thereby cooling the battery system 100 and the power electronic component 200. Here, the cooling water passing through the radiator 400 passes through the chiller 500 but the chiller 500 is in the turned off state like the battery heater 300 and therefore has no effect on the temperature of the cooling water.

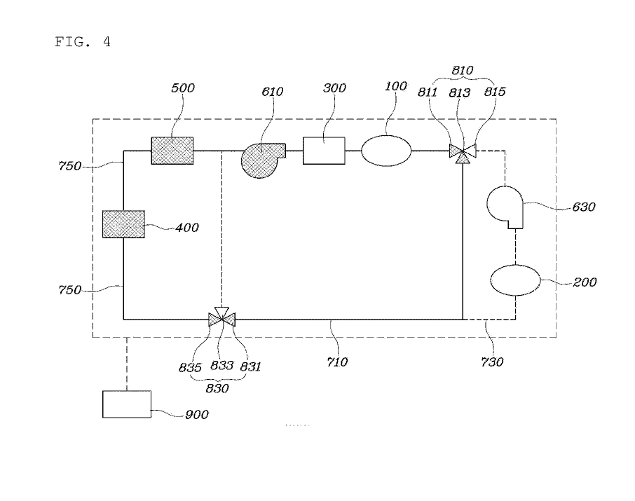

Third, FIG. 4 is a diagram illustrating a flow of cooling water when only the battery system 100 is cooled by the radiator 400 and the chiller 500. When the battery system 100 needs to be cooled more powerfully than in the situation of FIG. 2 due to driving of a vehicle, or the like under the environment that temperature is high like a summer, the controller 900 controls the first water pump 610 and the chiller 500 to be turned on and controls the first stage 811 and the second stage 813 of the first three way valve 810 and the first stage 831 and the third stage 835 of the second three way valve 830 to be open. Therefore, one closed loop consisting of the first water pump 610, the battery heater 300, the battery system 100, the first three way valve 810, the first passage 710, the second three way valve 830, the third passage 750, the radiator 400, and the chiller 500 is formed, such that the cooling water is repeatedly circulated in the closed loop.

First, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710 through the first three way valve 810, the heated cooling water is introduced into the first stage 811 of the first three way valve 810 and then discharged to the second stage 813. After the cooling water is introduced into the first stage 831 of the second three way valve 830, discharged to the third stage 835, and introduced into the third passage 750 to be cooled by the radiator 400, the cooling water passes through the chiller 500 to be cooled once more and then moves in the first passage 710 to pass through the first water pump 610 again and be supplied to the battery system 100 to thereby be repeatedly circulated in the closed loop, thereby cooling the battery system 100.

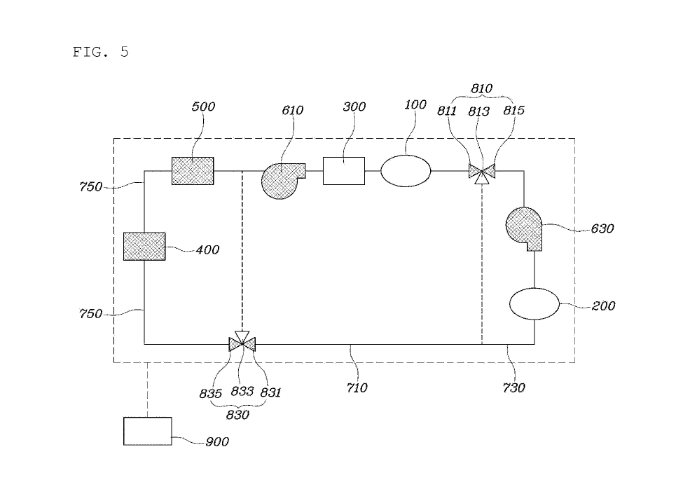

Fourth, FIG. 5 is a diagram illustrating a flow of cooling water when the battery system 100 and the power electronic component 200 are simultaneously cooled by the radiator 400 and the chiller 500. When the battery system 100 and the power electronic component 200 need to be cooled more powerfully than in the situation of FIG. 3 due to driving of a vehicle, or the like under the environment that temperature is high in summer, the controller 900 controls the first water pump 610, the second water pump 630, and the chiller 500 to be turned on and controls the first stage 811 and the third stage 815 of the first three way valve 810 and the first stage 831 and the third stage 835 of the second three way valve 830 to be open.

To simultaneously cool the battery system 100 and the power electronic component 200, first, one closed loop consisting of the first water pump 610, the battery heater 300, the battery system 100, the first passage 710, the first three way valve 810, the second passage 730, the second water pump 630, the power electronic component 200, the first passage 710, the second three way valve 830, the third passage 750, the radiator 400, and the chiller 500 is formed, such that the cooling water is repeatedly circulated in the closed loop. As described above, when the battery system 100 and the power electronic component 200 are simultaneously cooled, a part of the first passage 710 is blocked by the first three way valve 810 and the second three way valve 830 and all of the battery system 100, the power electronic component 200, and the radiator 400 are connected in series to form one closed loop to thereby circulate the cooling water.

Describing the flow of the cooling water, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710, the heated cooling water is introduced into the first stage 811 of the first three way valve 810, is discharged to the third stage 815, moves in the second passage 730, and then is introduced into the second water pump 630. After the cooling water introduced into the second water pump 630 cools the power electronic component 200, moves in the first passage 710, is introduced into the first stage 831 of the second three way valve 830, is discharged to the third stage 835, and moves in the third passage 750 to be cooled by the radiator 400, the cooling water moves in the first passage 710 through the chiller 500 to pass through the first water pump 610 again and be supplied to the battery system 100 to thereby be repeatedly circulated in the closed loop, thereby cooling the battery system 100.

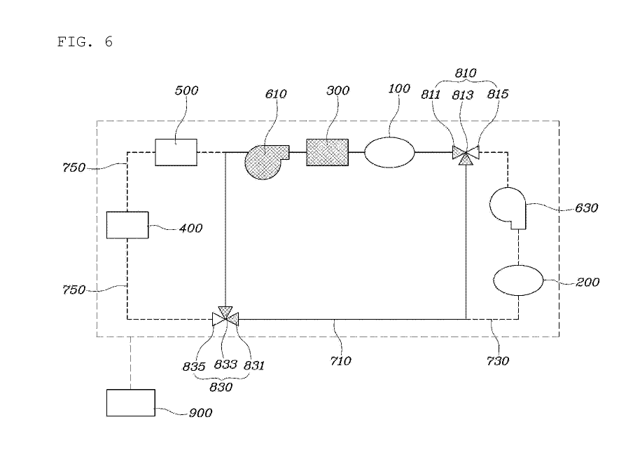

Finally, FIG. 6 is a diagram illustrating a flow of cooling water when only the battery system 100 is heated by the battery heater 300. When the battery system 100 needs to be heated due to driving of a vehicle, or the like in winter, the controller 900 controls the first water pump 610 and the battery heater 300 to be turned on and controls the first stage 811 and the second stage 813 of the first three way valve 810 and the first stage 831 and the second stage 833 of the second three way valve 830 to be open. Therefore, one closed loop consisting of the first water pump 610, the battery heater 300, the battery system 100, the first passage 710, and the first three way valve 810 is formed, such that the cooling water is repeatedly circulated in the closed loop.

First, the cooling water of the first water pump 610 passes through the battery heater 300. Differently from the case of cooling the battery system 100 or the power electronic component 200 that should be cooled, the battery heater 300 is in a turned on state, and therefore the temperature of the cooling water rises. The cooling water heated by passing through the battery heater 300 is introduced into the battery system 100 to heat the battery system 100. When the cooling water discharged from the battery system 100 moves in the first passage 710, the cooling water is introduced into the first stage 811 of the first three way valve 810, discharged to the second stage 813 to be introduced into the first stage 831 of the second three way valve 830 during being circulated in the first passage 710, and then discharged to the second stage 833 to pass through the first water pump 610 and the battery heater 300 again through the first passage 710 and be supplied to the battery system 100 to thereby be repeatedly circulated in the closed loop, thereby heating the battery system 100.

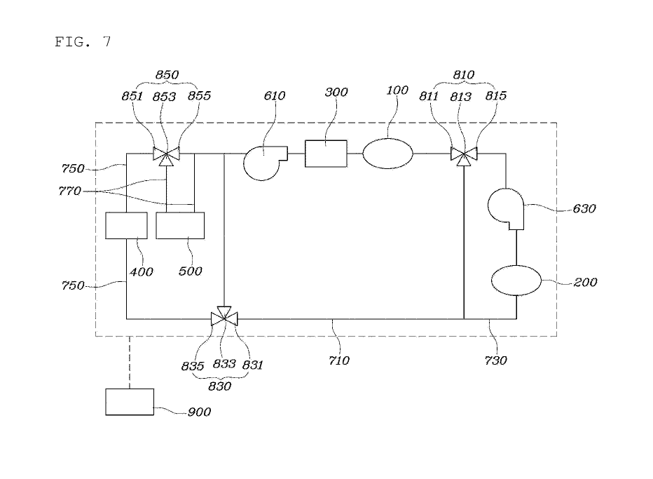

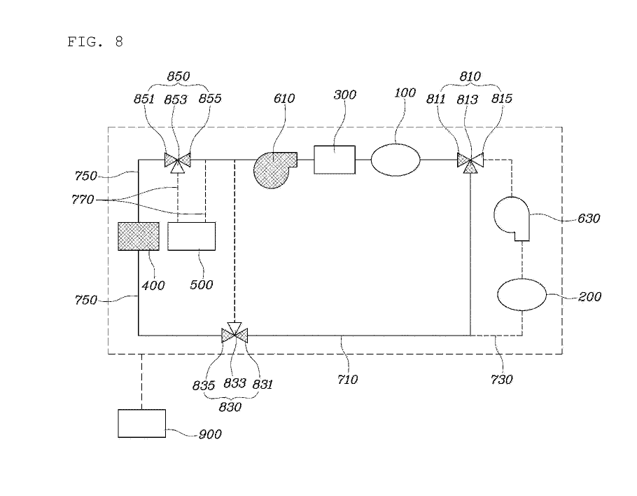

FIG. 7 is a diagram illustrating a water cooled type cooling-heating system according to an exemplary embodiment of the present invention and FIGS. 8 to 12 are diagrams illustrating control methods in each case.

As illustrated in FIG. 7, according to a second exemplary embodiment of the present invention, a water cooled type cooling-heating system for cooling or heating a battery system 100 and cooling a power electronic component 200, in a vehicle equipped with a high voltage battery by cooling water includes: a first passage 710 configured to have a first water pump 610, a battery heater 300, and the battery system 100 disposed in order thereon so as to circulate the cooling water; a second passage 730 configured to be branched from the first passage 710, have a parallel structure with the first passage 710, and have a second water pump 630 and the power electronic component 200 disposed in order thereon so as to move the cooling water; a third passage 750 configured to be branched from the first passage 710, have a parallel structure with the first passage 710, and include a radiator 400 and a chiller 500 to move the cooling water so as to perform cooling; a first three way valve 810 configured to be disposed at a point between a rear of the battery system 100 and the second water pump 630 where the first passage 710 and the second passage 730 are met and include a first stage 811 into which the cooling water discharged from the battery system 100 is introduced, a second stage 813 through which the cooling water is discharged to the first passage 710, and a third stage 815 through which the cooling water is discharged to the first water pump 610 to selectively move the cooling water; a second three way valve 830 configured to be disposed at a point where the first passage 710 and the third passage 750 are met and include a first stage 831 into which the cooling water is introduced from the first passage 710, a second stage 833 through which the cooling water is discharged to the first passage 710, and a third stage 835 through which the cooling water is discharged to the third passage 750 to selectively move the cooling water; and a controller 900 configured to separately control the first water pump 610, the second water pump 630, the battery heater 300 and the chiller 500 to be turned on and off and separately control the first three way valve 810 and the second three way valve 830 to be closed and open to circulate the cooling water so as to cool or heat the battery system 100 and cool the power electronic component 200. According to the second exemplary embodiment of the present invention, a rear of the radiator 400 is provided with a fourth passage 770 branched from the third passage 750 to form the closed loop, the fourth passage 770 is provided with the chiller 500, and a point where the third passage 750 and the fourth passage 770 are met is provided with a third three way valve 850 including a first stage 851 into which the cooling water discharged from the radiator 400 is introduced, a second stage 853 through which the cooling water is introduced into the chiller 500, and a third stage 855 through which the cooling water is discharged from the chiller 500. That is, in the first exemplary embodiment of the present invention, the radiator 400 and the chiller 500 are configured in series, but in the second exemplary embodiment of the present invention, the radiator 400 and the chiller 500 are connected in parallel by the third three way valve 850 and the fourth passage 770.

FIG. 8 is a diagram illustrating a flow of cooling water when only the battery system 100 is cooled by the radiator 400. When the battery system 100 needs to be cooled due to driving of a vehicle, or the like, the controller 900 controls the first water pump 610 to be turned on and controls the first stage 811 and the second stage 813 of the first three way valve 810, the first stage 831 and the third stage 835 of the second three way valve 830, and the first stage 851 and the third stage 855 of the third three way valve 850 to be open. Therefore, one closed loop consisting of the first water pump 610, the battery heater 300, the battery system 100, the first three way valve 810, the first passage 710, the second three way valve 830, the third passage 750, the radiator 400, and the third three way valve 850 is formed, such that the cooling water is repeatedly circulated in the closed loop.

First, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710 through the first three way valve 810, the heated cooling water is introduced into the first stage 811 of the first three way valve 810 and then discharged to the second stage 813. After the cooling water is introduced into the first stage 831 of the second three way valve 830, discharged to the third stage 835, and introduced into the third passage 750 to be cooled by the radiator 400, the cooling water moves in the first passage 710 through the third three way valve 850 to pass through the first water pump 610 again and be supplied to the battery system 100 to thereby be repeatedly circulated in the closed loop, thereby cooling the battery system 100.

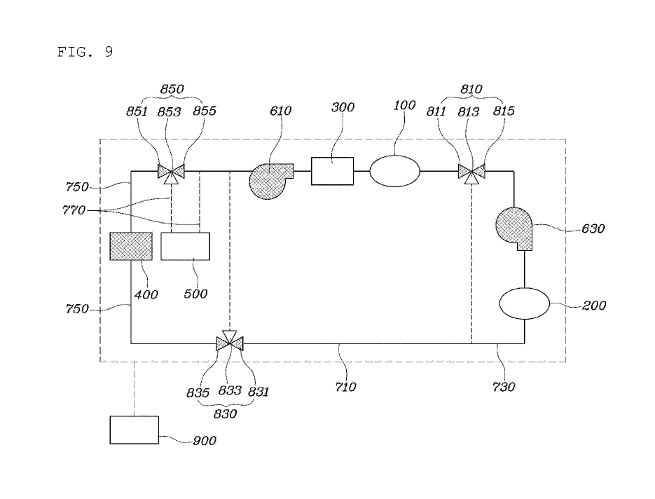

Second, FIG. 9 is a diagram illustrating a flow of cooling water when the battery system 100 and the power electronic component 200 are simultaneously cooled by the radiator 400. When the battery system 100 and the power electronic component 200 need to be cooled due to driving of a vehicle, or the like, the controller 900 controls the first water pump 610 and the second water pump 630 to be turned on and controls the first stage 811 and the third stage 815 of the first three way valve 810, the first stage 831 and the third stage 835 of the second three way valve 830, and the first stage 851 and the third stage 855 of the third three way valve 850 to be open.

To simultaneously cool the battery system 100 and the power electronic component 200, first, one closed loop consisting of the first water pump 610, the battery heater 300, the battery system 100, the first passage 710, the first three way valve 810, the second passage 730, the second water pump 630, the power electronic component 200, the first passage 710, the second three way valve 830, the third passage 750, the radiator 400, and the third three way valve 850 is formed, such that the cooling water is repeatedly circulated in the closed loop. As described above, when the battery system 100 and the power electronic component 200 are simultaneously cooled, a part of the first passage 710 is blocked by the first three way valve 810 and the second three way valve 830 and all of the battery system 100, the power electronic component 200, and the radiator 400 are connected in series to form one closed loop to thereby circulate the cooling water.

Describing the flow of the cooling water, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710, the heated cooling water is introduced into the first stage 811 of the first three way valve 810, is discharged to the third stage 815, moves in the second passage 730, and then is introduced into the second water pump 630. After the cooling water introduced into the second water pump 630 cools the power electronic component 200, moves in the first passage 710, is introduced into the first stage 831 of the second three way valve 830, is discharged to the third stage 835, and moves in the third passage 750 to be cooled by the radiator 400, the cooling water moves in the first passage 710 through the third three way valve 850 to pass through the first water pump 610 again and be supplied to the battery system 100 to thereby be repeatedly circulated in the closed loop, thereby cooling the battery system 100 and the power electronic component 200.

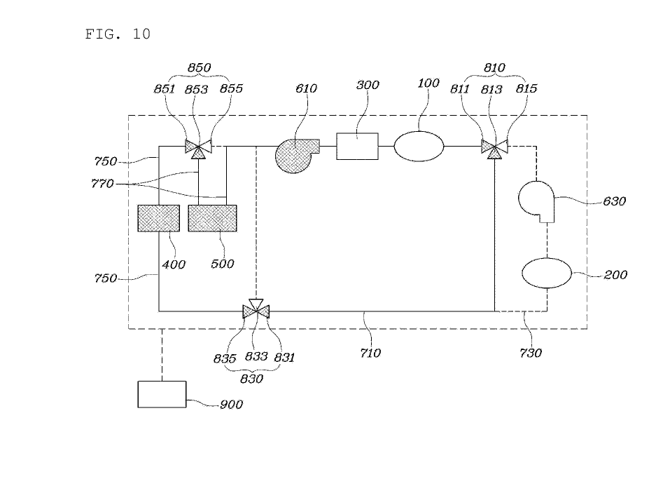

Third, FIG. 10 is a diagram illustrating a flow of cooling water when only the battery system 100 is cooled by the radiator 400 and the chiller 500. When the battery system 100 needs to be cooled more powerfully than in the situation of FIG. 8 due to driving of a vehicle, or the like under the environment that temperature is high in summer, the controller 900 controls the first water pump 610 and the chiller 500 to be turned on and controls the first stage 811 and the second stage 813 of the first three way valve 810, the first stage 831 and the second stage 833 of the second three way valve 830, and the first stage 851 and the second stage 853 of the third three way valve 850 to be open. Therefore, one closed loop consisting of the first water pump 610, the battery heater 300, the battery system 100, the first three way valve 810, the first passage 710, the second three way valve 830, the third passage 750, the radiator 400, the third three way valve 850, the fourth passage 770, and the chiller 500 is formed, such that the cooling water is repeatedly circulated in the closed loop.

First, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710 through the first three way valve 810, the heated cooling water is introduced into the first stage 811 of the first three way valve 810 and then discharged to the second stage 813. After the cooling water is introduced into the first stage 831 of the second three way valve 830, discharged to the third stage 835, and introduced into the third passage 750 to be cooled by the radiator 400, the cooling water is introduced into the fourth passage 770 through the third three way valve 850, passes through the chiller 500 to be cooled once more, and then moves in the first passage 710 to pass through the first water pump 610 again and be supplied to the battery system 100 to thereby be repeatedly circulated in the closed loop, thereby cooling the battery system 100.

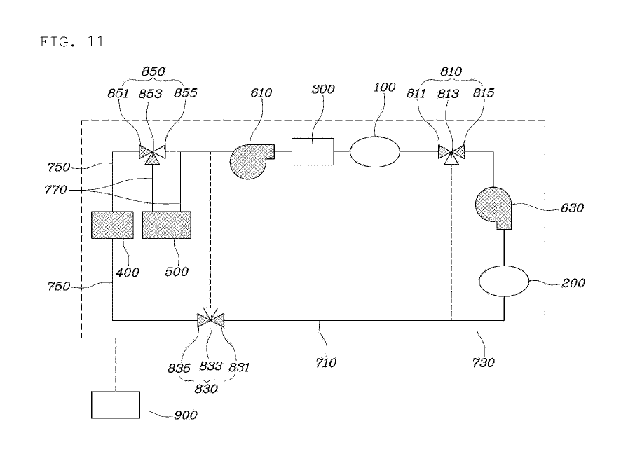

Fourth, FIG. 11 is a diagram illustrating a flow of cooling water when the battery system 100 and the power electronic component 200 are simultaneously cooled by the radiator 400 and the chiller 500. When the battery system 100 and the power electronic component 200 need to be cooled more powerfully than in the situation of FIG. 3 due to driving of a vehicle, or the like under the environment that temperature is high as in summer, the controller 900 controls the first water pump 610, the second water pump 630, and the chiller 500 to be turned on and controls the first stage 811 and the third stage 815 of the first three way valve 810, the first stage 831 and the second stage 833 of the second three way valve 830, and the first stage 851 and the second stage 853 of the third three way valve 850 to be open.

To simultaneously cool the battery system 100 and the power electronic component 200, first, one closed loop consisting of the first water pump 610, the battery heater 300, the battery system 100, the first passage 710, the first three way valve 810, the second passage 730, the second water pump 630, the power electronic component 200, the first passage 710, the second three way valve 830, the third passage 750, the radiator 400, the third three way valve 850, and the chiller 500 is formed, such that the cooling water is repeatedly circulated in the closed loop. As described above, when the battery system 100 and the power electronic component 200 are simultaneously cooled, a part of the first passage 710 is blocked by the first three way valve 810 and the second three way valve 830 and all of the battery system 100, the power electronic component 200, the radiator 400, and the chiller 500 are connected in series to form one closed loop to thereby circulate the cooling water.

Describing the flow of the cooling water, the cooling water of the first water pump 610 passes through the battery heater 300. However, the battery heater 300 is in the turned off state and therefore has no effect on the temperature of the cooling water. The cooling water passing through the battery heater 300 is introduced into the battery system 100 to cool and heat the battery system 100. When the heated cooling water moves in the first passage 710, the heated cooling water is introduced into the first stage 811 of the first three way valve 810, is discharged to the third stage 815, moves in the second passage 730, and then is introduced into the second water pump 630. After the cooling water introduced into the second water pump 630 cools the power electronic component 200, moves in the first passage 710, is introduced into the first stage 831 of the second three way valve 830, is discharged to the third stage 835 of the second three way valve, and moves in the third passage 750 to be cooled by the radiator 400, the cooling water moves in the fourth passage 770 through the third three way valve 850, passes through the chiller 500 to be cooled once more, and then moves in the first passage 710 through the chiller 500 to pass through the first water pump 610 again and be supplied to the battery system 100 to thereby be repeatedly circulated in the closed loop, thereby cooling the battery system 100.

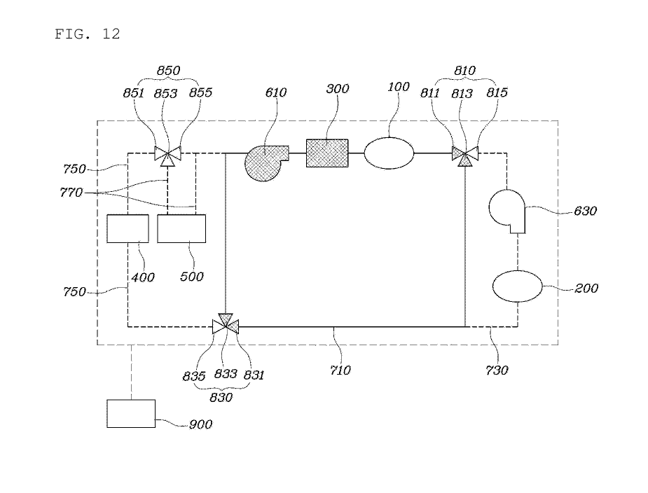

Finally, FIG. 12 is a diagram illustrating a flow of cooling water when only the battery system 100 is heated by the battery heater 300. When the battery system 100 needs to be heated due to driving of a vehicle, or the like in winter, the controller 900 controls the first water pump 610 and the battery heater 300 to be turned on and controls the first stage 811 and the second stage 813 of the first three way valve 810 and the first stage 831 and the second stage 833 of the second three way valve 830 to be open. Therefore, one closed loop consisting of the first water pump 610, the battery heater 300, the battery system 100, the first passage 710, and the first three way valve 810 is formed, such that the cooling water is repeatedly circulated in the closed loop.

First, the cooling water of the first water pump 610 passes through the battery heater 300. Differently from the case of cooling the battery system 100 or the power electronic component 200 that should be cooled, the battery heater 300 is in a turned on state, and therefore the temperature of the cooling water rises. The cooling water heated by passing through the battery heater 300 is introduced into the battery system 100 to heat the battery system 100. When the cooling water discharged from the battery system 100 moves in the first passage 710, the cooling water is introduced into the first stage 811 of the first three way valve 810, discharged to the second stage 813 to be introduced into the first stage 831 of the second three way valve 830 during being circulated in the first passage 710, and then discharged to the second stage 833 to pass through the first water pump 610 and the battery heater 300 again through the first passage 710 and be supplied to the battery system 100 to thereby be repeatedly circulated in the closed loop, thereby heating the battery system 100.

The water cooled type cooling-heating system according to the exemplary embodiment of the present invention as described above may be particularly applied to eco-friendly vehicles equipped with the high voltage battery system. The present invention relates to a layout to dispose and configure components involved in the cooling or heating of the battery system 100 and cooling the power electronic component 200 so as to cool or heat the battery system 100 and cool the power electronic component 200, in the eco-friendly vehicles. Here, when the battery system 100 and the power electronic component 200 need to be cooled during driving of the vehicle or during the summer, only the radiator 400 is driven or the chiller 500 is additionally driven according to the environment of the vehicle to cool the battery system 100 and the power electronic components 200 and when the battery system 100 needs to be heated during winter, the battery heater 300 is disposed in front of the battery system 100 and the plurality of three way valves are disposed in back of the battery system 100 to control the plurality of three way valves to be open and closed to thereby selectively close or open the plurality of passages, thereby selectively cooling or heating the battery system 100.

Therefore, the water cooled type cooling-heating system according to the exemplary embodiments of the present invention, it is possible to increase the driving distance of the vehicle and increase the durability of the parts by selectively and efficiently performing the cooling, the additional cooling, or the heating of the battery system 100 and selectively and efficiently performing the cooling or the additional cooling of the power electronic component 200, only with the simple structure.

According to the water cooled type cooling-heating system having the structure as described above, it is possible to increase the driving distance of the vehicle and increase the durability of the parts by selectively and efficiently performing the cooling, the additional cooling, or the heating of the battery system and selectively and efficiently performing the cooling or the additional cooling of the power electronic component.

Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. A water cooled type cooling-heating system for cooling or heating power supply components in a vehicle, the system comprising:
a first passage configured to have a first water pump, a battery heater, and a battery system disposed in order thereon so as to circulate the cooling water;
a second passage configured to be branched from the first passage, have a parallel structure with the first passage, and have a second water pump and a power electronic component disposed in order thereon so as to move the cooling water;
a third passage configured to be branched from the first passage, have a parallel structure with the first passage, and including a radiator and a chiller to move the cooling water;
a first three way valve configured to be disposed at a point between a rear of the battery system and the second water pump where the first passage and the second passage meet, the first three way value includes
a first stage into which the cooling water discharged from the battery system is introduced,
a second stage through which the cooling water is discharged to the first passage, and
a third stage through which the cooling water is discharged to the second water pump to selectively move the cooling water;
a second three way valve configured to be disposed at a point where the first passage and the third passage meet, the second three way valve including
a first stage into which the cooling water is introduced from the first passage,
a second stage through which the cooling water is discharged to the first passage, and
a third stage through which the cooling water is discharged to the third passage to selectively move the cooling water; and
a controller configured to separately control the first water pump, the second water pump, the battery heater, and the chiller to be turned on and off and separately control the first three way valve and the second three way valve to be closed and open to circulate the cooling water so as to cool or heat the battery system and cool of the power electronic component.

2. The water cooled type cooling-heating system of claim 1, wherein the chiller is disposed in back of the radiator.

3. The water cooled type cooling-heating system of claim 2, wherein the controller is configured to cool the battery system by
controlling the first water pump to be turned on and
controlling the first stage and the second stage of the first three way valve and the first stage and the third stage of the second three way valve to be open, such that the cooling water of the first water pump cools the battery system and the heated cooling water moves in the first passage through the first three way valve and is introduced into the third passage through the second three way valve to be cooled by the radiator and then moves in the first passage to pass through the first water pump again and be supplied to the battery system.

4. The water cooled type cooling-heating system of claim 2, wherein the controller is configured to cool the battery system and the power electronic component by
controlling the first water pump and the second water pump to be turned on and
controlling the first stage and the third stage of the first three way valve and the first stage and the third stage of the second three way valve to be open, such that the cooling water of the first water pump cools the battery system and then moves in the second passage through the first three way valve and is introduced into the second water pump and the cooling water of the second water pump cools the power electronic component and then moves in the first passage to move in the third passage through the second three way valve to be cooled by the radiator and then moves in the first passage to pass through the first water pump again and be supplied to the battery system.

5. The water cooled type cooling-heating system of claim 2, wherein the controller is configured to cool the battery system by
controlling the first water pump and the chiller to be turned on and
controlling the first stage and the second stage of the first three way valve and the first stage and the third stage of the second three way valve to be open, such that the cooling water of the first water pump cools the battery system and the heated cooling water moves in the first passage through the first three way valve, and moves in the third passage through the second three way valve to be cooled by the radiator and then passes through the chiller to be cooled once more and then moves in the first passage to pass through the first water pump again and be supplied to the battery system.

6. The water cooled type cooling-heating system of claim 2, wherein the controller is configured to cool the battery system and the power electronic component by
controlling the first water pump, the second water pump, and the chiller to be turned on and
controlling the first stage and the third stage of the first three way valve and the first stage and the third stage of the second three way valve to be open, such that the cooling water of the first water pump cools the battery system and then moves in the second passage through the first three way valve to cool the power electronic component using the second water pump and the heated cooling water moves in the first passage to move in the third passage through the second three way valve to be cooled by the radiator and then passes through the chiller to be cooled once more and then moves in the first passage to pass through the first water pump again and be supplied to the battery system.

7. The water cooled type cooling-heating system of claim 2, wherein the controller is configured to heat the battery system by
controlling the first water pump and the battery heater to be turned on and
controlling the first stage and the second stage of the first three way valve and the first stage and the second stage of the second three way valve to be open, such that the cooling water of the first water pump passes through the battery heater to be heated and then is introduced into the battery system to heat the battery system and is circulated in the first passage through the first three way valve and the second three way valve to pass through the first water pump again so as to pass through the battery heater and be supplied to the battery system.

8. The water cooled type cooling-heating system of claim 1, wherein a rear of the radiator is provided with a fourth passage branched from the third passage to form a closed loop, the fourth passage being provided with the chiller, and a point where the third passage and the fourth passage meet is provided with a third three way valve including
a first stage into which the cooling water discharged from the radiator is introduced,
a second stage through which the cooling water is introduced into the chiller, and
a third stage through which the cooling water is discharged from the chiller.

9. The water cooled type cooling-heating system of claim 8, wherein the controller is configured to cool the battery system by
controlling the first water pump to be turned on and
controlling the first stage and the second stage of the first three way valve, the first stage and the third stage of the second three way valve, and the first stage and the third stage of the third three way valve to be open, such that the cooling water of the first water pump cools the battery system and the heated cooling water moves in the first passage through the first three way valve and is introduced into the third passage through the second three way valve to be cooled by the radiator and then moves in the first passage through the third three way valve to pass through the first water pump again and be supplied to the battery system.

10. The water cooled type cooling-heating system of claim 8, wherein the controller is configured to cool the battery system and the power electronic component by
controlling the first water pump and the second water pump to be turned on and
controlling the first stage and the third stage of the first three way valve, the first stage and the third stage of the second three way valve, and the first stage and the third stage of the third three way valve to be open, such that the cooling water of the first water pump cools the battery system and then moves in the second passage through the first three way valve and is introduced into the second water pump and the cooling water of the second water pump cools the power electronic component and then moves in the first passage to move in the third passage through the second three way valve to be cooled by the radiator and then moves in the first passage through the third three way valve to pass through the first water pump again and be supplied to the battery system.

11. The water cooled type cooling-heating system of claim 8, wherein the controller is configured to cool the battery system by
controlling the first water pump and the chiller to be turned on and
controlling the first stage and the second stage of the first three way valve, the first stage and the third stage of the second three way valve, and the first stage and the second stage of the third three way valve to be open, such that the cooling water of the first water pump cools the battery system and the heated cooling water moves in the first passage through the first three way valve, and moves in the third passage through the second three way valve to be cooled by the radiator and then is introduced into the fourth passage through the third three way valve to pass through the chiller to be cooled once more and then moves in the first passage to pass through the first water pump again and be supplied to the battery system.

12. The water cooled type cooling-heating system of claim 8, wherein the controller is configured to cool the battery system and the power electronic component by
controlling the first water pump, the second water pump, and the chiller to be turned on and
controlling the first stage and the third stage of the first three way valve, the first stage and the third stage of the second three way valve, and the first stage and the second stage of the third three way valve to be open, such that the cooling water of the first water pump cools the battery system and then moves in the second passage through the first three way valve to cool the power electronic component using the second water pump and the heated cooling water moves in the first passage to move in the third passage through the second three way valve to be cooled by the radiator and then is introduced into the fourth passage through the third three way valve to pass through the chiller to be cooled once more and then moves in the first passage to pass through the first water pump again and be supplied to the battery system.

13. The water cooled type cooling-heating system of claim 8, wherein the controller is configured to heat the battery system by
controlling the first water pump and the battery heater to be turned on, and
controlling the first stage and the second stage of the first three way valve and the first stage and the second stage of the second three way valve to be open, such that the cooling water of the first water pump passes through the battery heater to be heated and then is introduced into the battery system to heat the battery system and is circulated in the first passage through the first three way valve and the second three way valve to pass through the first water pump again so as to pass through the battery heater and be supplied to the battery system.

14. A water cooled type cooling-heating system for cooling or heating a battery system and cooling a power electronic component, the system comprising:
a first water pump, a battery heater, and the battery system sequentially arranged forming a first passage configured to circulate a cooling water;
a second water pump and the power electronic component sequentially arranged forming a second passage, the second passage configured to be branched from the first passage and having a parallel structure with the first passage;
a radiator and a chiller arranged forming a third passage to move the cooling water, the third passage configured to be branched from the first passage, and having a parallel structure with the first passage;
a first three way valve configured to be disposed at a point between the battery system and the second water pump where the first passage and the second passage meet, the first three way valve including
a first stage into which the cooling water discharged from the battery system is introduced,
a second stage through which the cooling water is discharged to the first passage, and
a third stage through which the cooling water is discharged to the second water pump to selectively move the cooling water;
a second three way valve configured to be disposed at a point where the first passage and the third passage meet, the second three way value including
a first stage into which the cooling water is introduced from the first passage,
a second stage through which the cooling water is discharged to the first passage, and
a third stage through which the cooling water is discharged to the third passage to selectively move the cooling water; and
a controller configured to
separately control the first water pump, the second water pump, the battery heater, and the chiller and
separately control the first three way valve and the second three way valve.

15. The water cooled type cooling-heating system of claim 14, wherein when the battery system needs to be cooled, the controller is configured to
control the first water pump to be turned on, and
control the first stage and the second stage of the first three way valve and the first stage and the third stage of the second three way valve to be open.

16. The water cooled type cooling-heating system of claim 14, wherein when the battery system and the power electronic component need to be cooled, the controller is configured to
control the first water pump and the second water pump to be turned on and
control the first stage and the third stage of the first three way valve and the first stage and the third stage of the second three way valve to be open.

17. The water cooled type cooling-heating system of claim 14, wherein when the battery system needs to be cooled, the controller is configured to
control the first water pump and the chiller to be turned on and
control the first stage and the second stage of the first three way valve and the first stage and the third stage of the second three way valve to be open.

18. The water cooled type cooling-heating system of claim 14, wherein when the battery system and the power electronic component need to be cooled, the controller is configured to
control the first water pump, the second water pump, and the chiller to be turned on and
control the first stage and the third stage of the first three way valve and the first stage and the third stage of the second three way valve to be open.

19. The water cooled type cooling-heating system of claim 14, wherein when the battery system needs to be heated, the controller is configured to
control the first water pump and the battery heater to be turned on and
control the first stage and the second stage of the first three way valve and the first stage and the second stage of the second three way valve to be open.

20. A method for a cooling-heating system for cooling or heating power supply components in a vehicle, the method comprising:
circulating a cooling water through a first passage that is formed by sequentially arranging a first water pump, a battery heater, and the battery system;
branching the cooling water into a second passage that is formed by sequentially arranging a second water pump and the power electronic component, the second passage having a parallel structure with the first passage;
moving the cooling water through a third passage comprising a radiator and a chiller, the third passage being branched from the first passage, and having a parallel structure with the first passage;
using a first three way valve at a point between the battery system and the second water pump where the first passage and the second passage meet, the first three way valve including
a first stage into which the cooling water discharged from the battery system is introduced,
a second stage through which the cooling water is discharged to the first passage, and
a third stage through which the cooling water is discharged to the second water pump to selectively move the cooling water;
using a second three way valve at a point where the first passage and the third passage meet, the second three way value including
a first stage into which the cooling water is introduced from the first passage,
a second stage through which the cooling water is discharged to the first passage, and
a third stage through which the cooling water is discharged to the third passage to selectively move the cooling water;
using a controller, separately controlling the first water pump, the second water pump, the battery heater, and the chiller; and
using the controller, separately control the first three way valve and the second three way valve.
